(19) United States
(12) Patent Application Publication
(10) Pub. No.: US 2026/0180786 A1
(43) Pub. Date: Jun. 25, 2026

(54) INFORMATION PROCESSING APPARATUS, INFORMATION TERMINAL, AND NON-TRANSITORY COMPUTER READABLE MEDIUM

(71) Applicant: FUJIFILM Business Innovation Corp., Tokyo (JP)

(72) Inventors: Masahiko HARADA, Kanagawa (JP); Sho NAGASE, Kanagawa (JP); Atsushi MORI, Kanagawa (JP); Ryosuke NAKAI, Kanagawa (JP)

(73) Assignee: FUJIFILM Business Innovation Corp., Tokyo (JP)

(21) Appl. No.: 19/179,434

(22) Filed: Apr. 15, 2025

(30) Foreign Application Priority Data
Dec. 24, 2024 (JP) 2024-227958

(51) Int. Cl. H04L 9/08

(52) U.S. Cl. CPC H04L 9/0819

(57) ABSTRACT

An information processing apparatus includes a processor configured to: in a case where, after replacement of a first board with a second board, first encrypted data stored in a storage device taken over from the first board to the second board fails to be decrypted, acquire, from an external device connected via a different terminal, first encryption key data obtained by encrypting a first encryption key unique to the first board; and decrypt the first encrypted data by using the first encryption key decrypted from the acquired first encryption key data.

### CROSS-REFERENCE TO RELATED APPLICATIONS

This application is based on and claims priority under 35 USC 119 from Japanese Patent Application No. 2024-227958 filed December 24, 2024.

### BACKGROUND

### (i) Technical Field

The present disclosure relates to an information processing apparatus, an information terminal, and a non-transitory computer readable medium.

### (ii) Related Art

Printers and other devices are required to have high security for user data. For this reason, for example, the following conditions need to be satisfied.

### (1) Data on a removable storage device is encrypted by a specific algorithm.

### (2) A plain-text encryption key used for encryption is not stored on the same storage device as encrypted data.

### (3) A plain-text encryption key is not stored in a removable storage device.

Examples of the related art include Japanese Unexamined Patent Application Publication No. 2016-116227.

### SUMMARY

When printers and other devices are repaired, a board may need to be replaced. In this case, the storage device is removed from the old board and installed onto the new board.

However, an encryption key used to encrypt data is associated with a board on a one-to-one basis. For this reason, even when the storage device of the old board is transferred to the new board, it is difficult to decrypt and use the data stored in the storage device as it is. This is because the encryption key of the old board used to encrypt the data is different from the encryption key of the new board.

Aspects of non-limiting embodiments of the present disclosure relate to simplifying a device configuration as compared with a case where the encryption key data obtained by encrypting an encryption key unique to a board removed from an apparatus is backed up in another board in the same device.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to, in a case where, after replacement of a first board with a second board, first encrypted data stored in a storage device taken over from the first board to the second board fails to be decrypted, acquire, from an external device connected via a different terminal, first encryption key data obtained by encrypting a first encryption key unique to the first board, and decrypt the first encrypted data by using the first encryption key decrypted from the acquired first encryption key data.

### BRIEF DESCRIPTION OF THE DRAWINGS

Exemplary embodiments of the present disclosure will be described in detail based on the following figures, wherein:

FIG. 1 is a diagram illustrating an example of a system configuration assumed according to an exemplary embodiment;

FIG. 2 is a table illustrating an example of data in a database;

FIG. 3 is a diagram illustrating a configuration example of an image forming apparatus;

FIG. 4 is a table illustrating an example of an NDEF record stored in an NFC tag;

FIG. 5 is a diagram illustrating an example of data stored in a non-volatile memory;

FIG. 6 is a diagram illustrating a configuration example of a mobile terminal;

FIG. 7 is a flowchart illustrating an example of a part of a work procedure and a processing operation related to replacement of a control board;

FIG. 8 is a flowchart illustrating an example of a remaining part of the work procedure and the processing operation related to the replacement of the control board;

FIG. 9 is a table illustrating an example of an NDEF record in which a serial number unique to a control board (old), and the like, are written;

FIG. 10 is a flowchart illustrating a processing operation of a board replacement app installed in the mobile terminal;

FIG. 11 is a diagram illustrating replacement work of the control board described in steps S102 to S104 (see FIG. 7);

FIG. 12 is a diagram illustrating a processing operation in step S110 (see FIG. 7);

FIG. 13 is a diagram illustrating a processing operation in step S115 (see FIG. 8);

FIG. 14 is a diagram illustrating a processing operation in steps S115 and S116 (see FIG. 8);

FIG. 15 is a diagram illustrating a processing operation in steps S117 to S120 (see FIG. 8); and

FIG. 16 is a diagram illustrating a processing operation in steps S121 and S122 (see FIG. 8).

### DETAILED DESCRIPTION

Exemplary embodiments of the present disclosure will be described below with reference to the drawings.

### First Exemplary Embodiment

### System Configuration

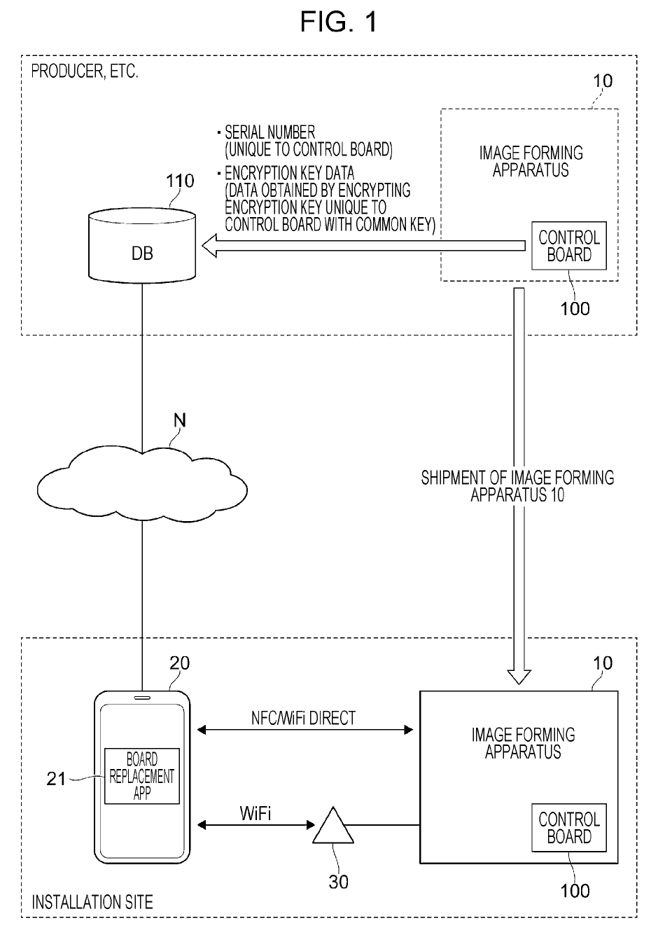

FIG. 1 is a diagram illustrating an example of a system configuration assumed according to an exemplary embodiment.

The system illustrated in FIG. 1 includes two subsystems. One is a subsystem operated by a business operator, etc. (hereinafter referred to as "producer, etc.") that produces an image forming apparatus 10. The other is a subsystem at a site (hereinafter referred to as "installation site") where the image forming apparatus 10 is installed. The image forming apparatus 10 is an example of an information processing apparatus.

The image forming apparatus 10 includes a control board 100.

For example, a board's unique encryption key used to encrypt user data or the like, a common key used to encrypt the encryption key, and a serial number unique to the control board 100 are recorded in the control board 100. There is a one-to-one correspondence between the control board 100 and the serial number. The serial number is an example of serial information unique to the control board.

The subsystem of the producer, etc. is provided with a database 110 connected to a network N. The database 110 is an example of an external device. The serial numbers of all the control boards 100 produced by the producer and the corresponding encryption key data are recorded in the database 110.

The database 110 may be operated by the producer of the image forming apparatus 10 or may be operated by a business operator commissioned by the producer.

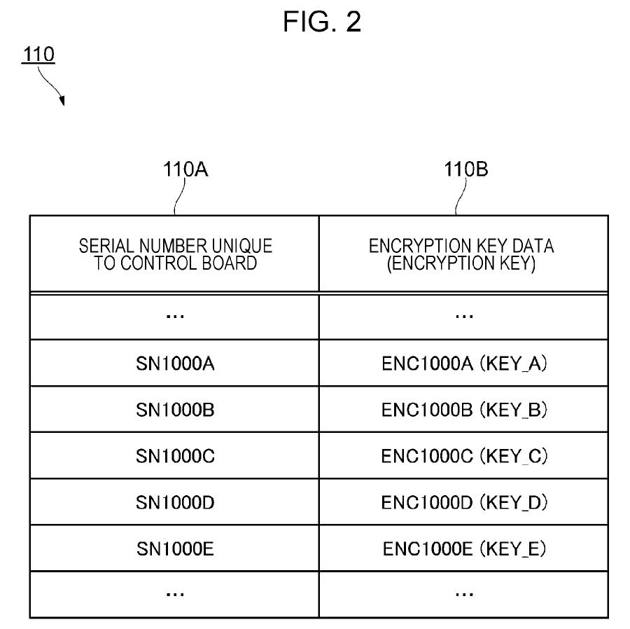

FIG. 2 is a table illustrating an example of data in the database 110.

In the database 110, encryption key data 110B is stored in association with a serial number 110A unique to the control board.

Although FIG. 2 also illustrates the information on the encryption key before encryption with the common key for convenience of description, the encryption key does not need to be stored.

In the case of FIG. 2, encryption key data ENC1000A is recorded in association with the serial number "SN1000A". The encryption key data ENC1000A is an example of first encryption key data.

The encryption key data ENC1000A is obtained by encrypting an encryption key KEY_A with a common key. Therefore, when the encryption key data ENC1000A is decrypted with the common key, the encryption key KEY_A is decrypted.

The encryption key KEY_A is an example of a first encryption key.

Similarly, encryption key data ENC1000B is recorded in association with the serial number "SN1000B".

The encryption key data ENC1000B is obtained by encrypting an encryption key KEY_B with the common key. Therefore, when the encryption key data ENC1000B is decrypted with the common key, the encryption key KEY_B is decrypted.

The encryption key KEY_B is also an example of the first encryption key.

For example, the place where the image forming apparatus 10 is used is assumed as the installation site. However, the installation site is not limited to the place where the image forming apparatus 10 is used. This is because it is assumed that the image forming apparatus 10 is brought into a repair facility.

In the case of FIG. 1, the installation site also includes a mobile terminal 20 such as a smartphone. The mobile terminal 20 is an example of an information terminal. The mobile terminal 20 is also an example of another terminal connected to the image forming apparatus 10.

According to the present exemplary embodiment, the mobile terminal 20 is carried by a customer engineer or the like who is in charge of maintaining the image forming apparatus 10. The mobile terminal 20 may be a terminal used by a user who uses the image forming apparatus 10.

However, the mobile terminal 20 is required to have a dedicated application program (hereinafter referred to as "board replacement app") 21 installed for use when the control board 100 is replaced.

According to the present exemplary embodiment, the image forming apparatus 10 and the mobile terminal 20 are compatible with at least Near Field Communication (NFC) communication. NFC is an example of a first communication interface.

The image forming apparatus 10 and the mobile terminal 20 are capable of performing wireless communication by Wi-Fi Direct or wireless communication by Wi-Fi via an access point 30. For example, the image forming apparatus 10 has a function of operating as a master device for the mobile terminal 20.

Alternatively, the image forming apparatus 10 has a communication function for connecting to the access point 30 via a local area network (LAN).

WiFi Direct or WiFi is an example of a second communication interface. The second communication interface is a wireless LAN.

According to the present exemplary embodiment, for the LAN that can be used by the image forming apparatus 10, communications with a device outside the installation location is restricted.

### <Configuration of Image Forming Apparatus>

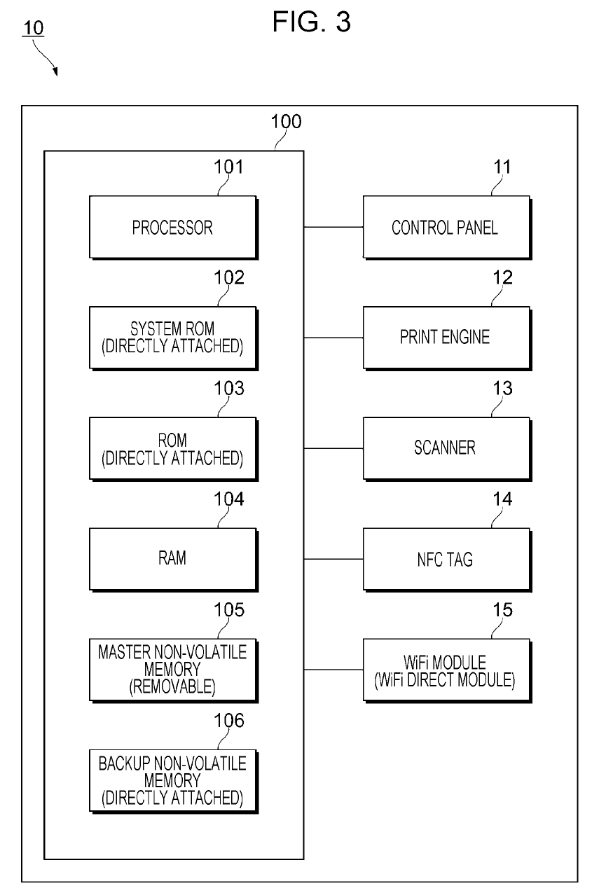

FIG. 3 is a diagram illustrating a configuration example of the image forming apparatus 10. In FIG. 3, the parts corresponding to the parts in FIG. 1 are denoted by the corresponding reference numerals.

The image forming apparatus 10 includes, for example, the control board 100, a control panel 11, a print engine 12, a scanner 13, an NFC tag 14, and a WiFi module 15.

The control panel 11 is a device that receives user operations. The control panel 11 is provided with, for example, a touch panel, a button, and a switch. The touch panel is, for example, a device having a structure in which capacitive translucent thin-film sensors are stacked on the surface of a display. The touch panel is an example of a device having functions of both an input device and an output device. The button and the switch are examples of mechanical operators.

The print engine 12 includes a processing device and an associated mechanism used to print information on a medium such as paper.

The processing device includes, for example, functional units related to rasterizing processing, density correction, sharpness correction, contrast correction, and background color removal.

The mechanism of the print engine 12 varies depending on the printing method. For example, the mechanism of the print engine 12 is different between a photographic printing method and an inkjet method.

A mechanism (i.e., a transport mechanism) for transporting a medium varies depending on whether the medium is cut paper or roll paper.

The scanner 13 is a device that optically reads information on the surface of a document. The scanner 13 supports at least one of the following methods: the method of moving a reading unit relative to a document in a stationary state; and the method of moving a document relative to a reading unit in a stationary state.

In the NFC tag 14, an IC chip capable of contactless communication with a device (for example, the mobile terminal 20) capable of NFC communication is embedded. The NFC tag 14 includes a static random access memory (SRAM), which is a type of volatile memory. The NFC tag 14 is an example of an NFC module.

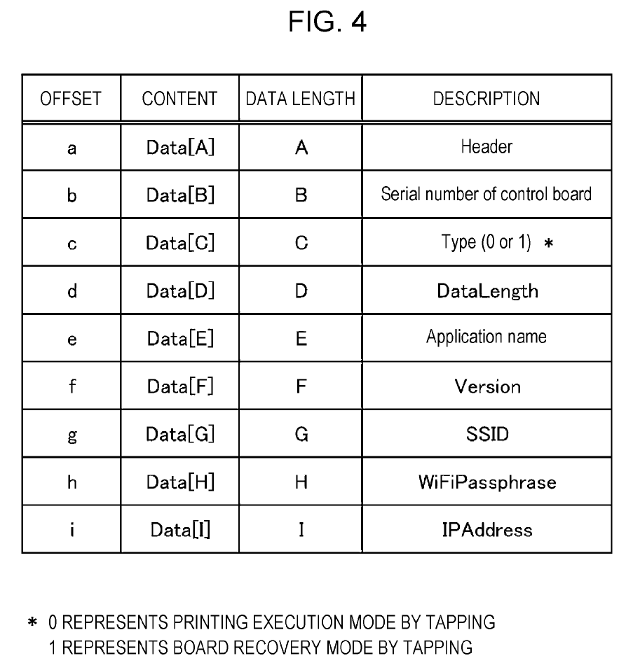

FIG. 4 is a table illustrating an example of an NFC Data Exchange Format (NDEF) record stored in the NFC tag 14. The NDEF record illustrated in FIG. 4 is a part of the data stored in the NFC tag 14.

In the offset a, the "header" information is recorded.

In the offset b, the "serial number of the control board" is recorded. With regard to the serial number, the serial number of the control board attached at the time of shipment is recorded. In the offset b, the serial number unique to the control board (old) before replacement is recorded at the time of replacement work of the control board (in the "board recovery mode" described below).

In the offset c, the "type" of the current operation mode is recorded. According to the present exemplary embodiment, "0" or "1" is recorded in the offset c. "0" represents "printing execution mode by tapping", and "1" represents "board recovery mode by tapping".

After the offset d, the information necessary for a handover connection is recorded. These pieces of information are known.

The above-described NDEF record is read by the mobile terminal 20 through a tapping operation.

A reference is made back to the description of FIG. 3.

The WiFi module 15 is a module that performs communication with a device (for example, the mobile terminal 20) connected via WiFi. A module having the function to directly connect to another device (for example, the mobile terminal 20) having a WiFi function is referred to as a WiFi Direct module.

When the WiFi module 15 is a WiFi Direct module, the image forming apparatus 10 operates as a master device for the mobile terminal 20 or the like. In this case, the image forming apparatus 10 can communicate with another device (for example, the mobile terminal 20) without the access point 30.

The control board 100 includes, for example, a processor 101, a system read only memory (ROM) 102, a ROM 103, a random access memory (RAM) 104, a master non-volatile memory 105, and a backup non-volatile memory 106.

The master non-volatile memory 105 is an example of a storage device to be taken over to the new control board 100 at the time of board replacement. Examples of the master non-volatile memory 105 include a secure digital (SD) memory card, a hard disk drive (i.e., magnetic recording device), and a semiconductor memory soldered to a sub-board connected to the control board 100 via a connector.

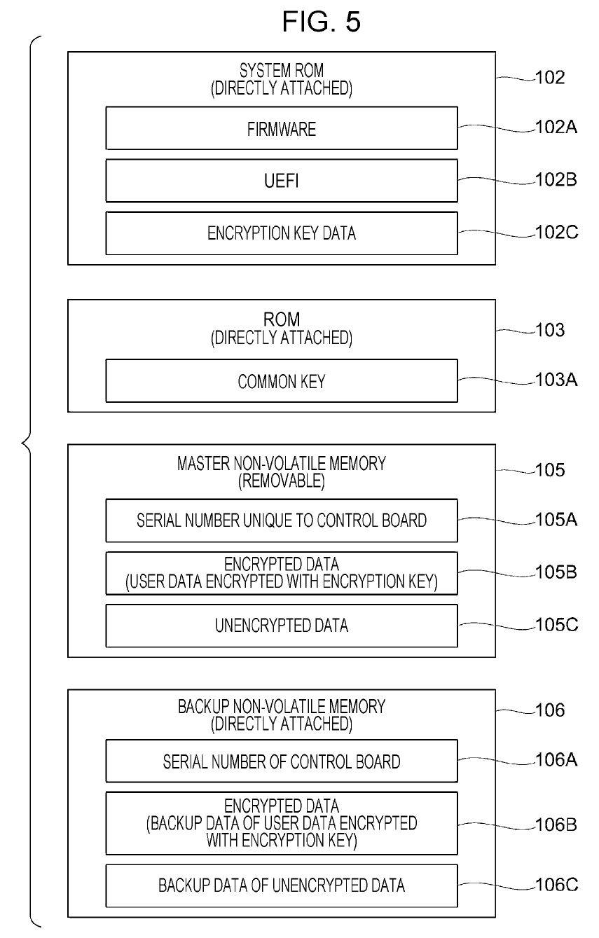

The processor 101 is a semiconductor device that performs various functions by executing programs. Examples of the programs include firmware 102A (see FIG. 5) and a unified extensible firmware interface (UEFI) 102B (see FIG. 5). In the UEFI 102B according to the present exemplary embodiment, the customer engineer mode (hereinafter also referred to as "diagnostic mode") is prepared.

The firmware 102A is a program that controls operations and functions of other devices such as the control panel 11 included in the image forming apparatus 10.

The UEFI 102B is a boot program that controls activation processing.

The system ROM 102 and the ROM 103 are directly attached to the control board 100. That is, the system ROM 102 and the ROM 103 cannot be physically removed from the control board 100 by a customer engineer or the like. For example, the system ROM 102 and the ROM 103 are soldered to the control board 100.

The system ROM 102 stores encryption key data 102C (see FIG. 5) in addition to the firmware 102A and the like described above. The encryption key data 102C is obtained by encrypting the encryption key (for example, KEY_A) unique to the control board 100 with a common key 103A (see FIG. 5), for example.

In the ROM 103, for example, the common key 103A is recorded. The common key 103A is a plain-text encryption key used to encrypt an encryption key unique to the control board 100. The common key 103A is written in the ROM 103 when the control board 100 is shipped.

With regard to security measures, the common key 103A, which is a plain-text encryption key, is prohibited from being stored on the same storage device as the encryption key data 102C. Further, the common key 103A is prohibited from being stored in a storage device removable from the control board 100. For this reason, according to the present exemplary embodiment, the common key 103A is stored in the ROM 103.

The RAM 104 is a semiconductor memory used as, for example, a program execution area.

For example, the processor 101, the system ROM 102, and the RAM 104 constitute a computer.

The master non-volatile memory 105 is a storage device removable from the control board 100. The master non-volatile memory 105 contains a serial number 105A (see FIG. 5) unique to the control board 100 attached at the time of shipment and user data (encrypted data 105B and unencrypted data 105C (see FIG. 5)).

The encrypted data 105B refers to user data encrypted with an encryption key unique to the control board 100. The encrypted user data includes information set by the user. The information set by the user is an example of highly confidential information. Therefore, the information is stored in a form of being encrypted with an encryption key.

The backup non-volatile memory 106 is a semiconductor memory directly attached to the control board 100. The backup non-volatile memory 106 stores data (backup data) obtained by duplicating data stored in the master non-volatile memory 105.

For this reason, the backup non-volatile memory 106 contains a serial number 106A (see FIG. 5) unique to the control board 100 attached at the time of shipment and backup data (encrypted data 106B and unencrypted data 106C (see FIG. 5)).

FIG. 5 is a diagram illustrating an example of data stored in the non-volatile memory.

The encryption key data 102C is stored in the system ROM 102. Conversely, the plain-text common key 103A used to generate the encryption key data 102C is stored in the ROM 103. That is, the encryption key data 102C and the common key 103A are stored in physically different non-volatile memories.

The plain-text common key 103A is stored in the semiconductor memory (i.e., the ROM 103) directly attached to the control board 100.

### Configuration of Mobile Terminal

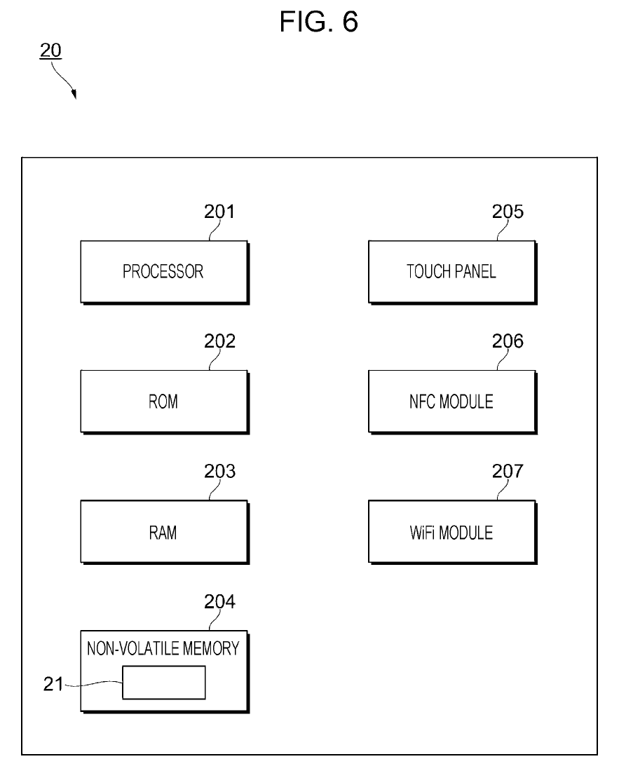

FIG. 6 is a diagram illustrating a configuration example of the mobile terminal 20. In FIG. 6, the parts corresponding to the parts in FIG. 1 are denoted by the corresponding reference numerals.

The mobile terminal 20 includes, for example, a processor 201, a ROM 202, a RAM 203, a non-volatile memory 204, a touch panel 205, an NFC module 206, and a WiFi module 207.

The mobile terminal 20 further includes a speaker, a microphone, and the like.

The ROM 202 stores, for example, firmware and an UEFI. The board replacement app 21 is installed in the non-volatile memory 204. The board replacement app 21 performs a processing operation at the time of board replacement described below.

The touch panel 205 is, for example, a device having a structure in which capacitive translucent thin-film sensors are stacked on the surface of a display.

The NFC module 206 is a device that reads an NDEF record from the NFC tag 14 (see FIG. 3).

The WiFi module 207 is an interface for WiFi communications.

### Control Board Replacement Work and Processing Operation

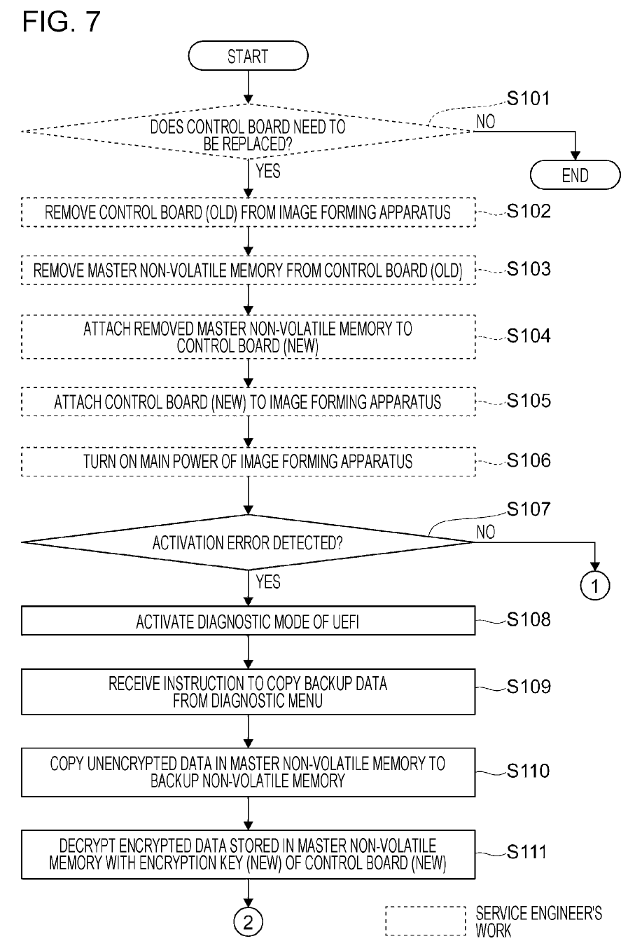

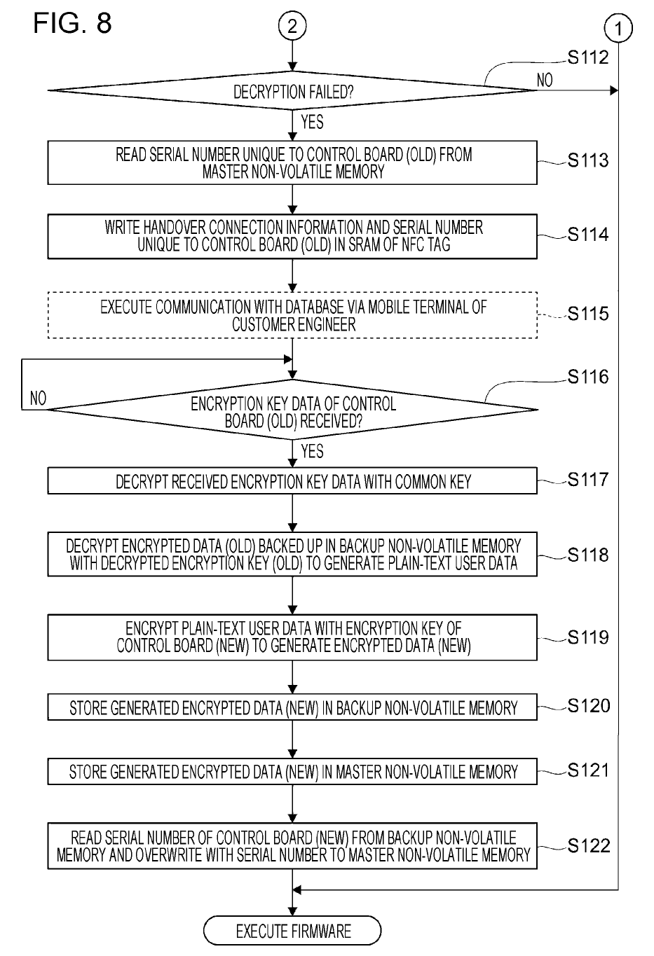

FIG. 7 is a flowchart illustrating an example of a part of a work procedure and a processing operation related to the replacement of the control board 100 (see FIG. 1). FIG. 8 is a flowchart illustrating an example of a remaining part of the work procedure and the processing operation related to the replacement of the control board 100 (see FIG. 1).

The work procedure and the processing operation illustrated in FIG. 8 correspond to the continuation of the work procedure and the processing operation illustrated in FIG. 7. The symbol S illustrated in FIGS. 7 and 8 represents a step.

When visiting the installation site due to a failure of the image forming apparatus 10 (see FIG. 1) or for inspection work, the customer engineer determines whether the control board 100 (see FIG. 1) needs to be replaced (step S101).

When it is determined that the control board 100 does not need to be replaced (for example, when the failure or the like is resolved by replacing a consumable part), a negative result is obtained in step S101. In this case, work other than the replacement of the control board 100 is executed. Therefore, the procedure does not proceed to the replacement of the control board 100.

When it is determined that the control board 100 needs to be replaced, a positive result is obtained in step S101. In this case, the customer engineer removes the control board 100 from the image forming apparatus 10 (step S102). In FIG. 7, the control board 100 removed from the image forming apparatus 10 is referred to as the "control board (old)".

The "control board (old)" is a term that refers to the currently attached faulty control board 100 and is used to distinguish the control board 100 from the newly attached control board 100. When it is necessary to distinguish between the newly attached control board 100 and the "control board (old)", the newly attached control board 100 is referred to as the "control board (new)".

The control board (old) is an example of a first board. The control board (new) is an example of a second board.

Then, the customer engineer removes the master non-volatile memory 105 (see FIG. 3) from the control board (old) (step S103). The master non-volatile memory 105 stores the serial number 105A (see FIG. 5) unique to the control board, the encrypted data 105B (see FIG. 5), and the unencrypted data 105C (see FIG. 5).

Then, the customer engineer attaches the removed master non-volatile memory 105 to the control board (new) (step S104).

Subsequently, the customer engineer attaches the control board (new) to the image forming apparatus 10 (step S105).

Then, the customer engineer turns on the main power of the image forming apparatus 10 (step S106).

Accordingly, the activation processing is started by the UEFI 102B (see FIG. 5). The activation processing of the UEFI 102B is executed by the processor 101 (see FIG. 3).

The processor 101 determines whether an activation error has been detected (step S107).

When an activation error has not been detected, a negative result is obtained in step S107.

When a negative result is obtained in step S107, for example, only the unencrypted data 105C may be stored in the master non-volatile memory 105. In this case, the processor 101 executes the firmware 102A (see FIG. 5). In other words, the image forming apparatus 10 is ready to be used.

Conversely, when an activation error has been detected, a positive result is obtained in step S107. In this case, the processor 101 activates the diagnostic mode of the UEFI 102B (step S108). The diagnostic mode is an example of a maintenance mode.

The processor 101 (see FIG. 3) receives an instruction to copy backup data from the diagnosis menu (step S109). The customer engineer gives a copy instruction. The copy instruction according to the present exemplary embodiment refers to execution of the board recovery mode.

Then, the processor 101 copies the unencrypted data 105C (see FIG. 5) in the master non-volatile memory 105 (see FIG. 5) to the backup non-volatile memory 106 (see FIG. 5) (step S110).

Subsequently, the processor 101 decrypts the encrypted data 105B stored in the master non-volatile memory 105 (see FIG. 5) with the encryption key (new) of the control board (new) (step S111). The encrypted data 105B is an example of first encrypted data.

The encryption key (new) is an encryption key unique to the control board (new) and is obtained by decrypting the encryption key data 102C (see FIG. 5) with the common key 103A (see FIG. 5).

Then, the processor 101 determines whether the decryption of the encrypted data 105B has failed (step S112).

When the decryption is successful, a negative result is obtained in step S112. In this case, the processor 101 returns to the menu screen of the diagnostic mode. When an instruction for the termination of the diagnostic mode is given, the firmware is executed.

Conversely, when the decryption has failed, a positive result is obtained in step S112. In this case, the processor 101 reads the serial number 105A, which is unique to the control board (old), from the master non-volatile memory 105 (see FIG. 5) (step S113).

Then, the processor 101 writes the handover connection information and the serial number unique to the control board (old) in the SRAM of the NFC tag 14 (see FIG. 3) (step S114).

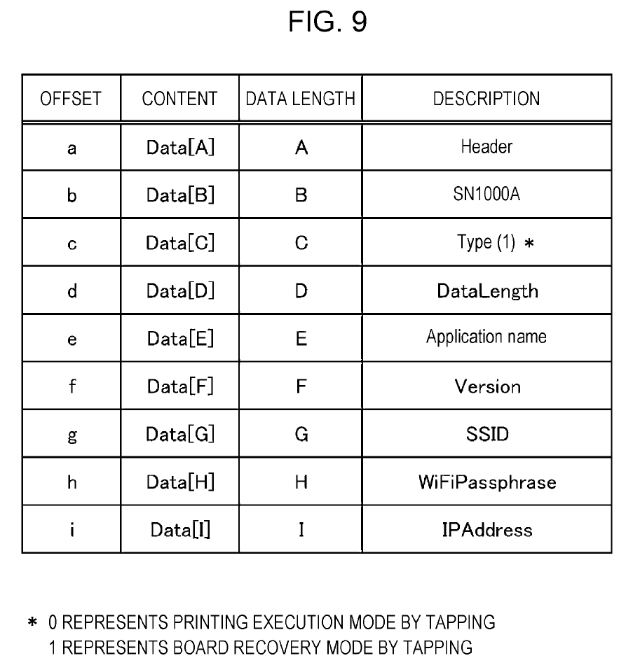

FIG. 9 is a table illustrating an example of an NDEF record in which the serial number unique to the control board (old), and the like, are written. The data structure illustrated in FIG. 9 corresponds to the data structure illustrated in FIG. 4.

In the case of FIG. 9, "SN1000A" is written in the offset b as the serial number unique to the control board (old). In the offset c, "type (1)" is written. "Type (1)" means that the current operation mode is the board recovery mode by tapping. Thus, preparation for the NFC tap is complete.

A reference is made back to the description of FIG. 8.

Then, the communication with the database 110 (see FIG. 1) via the mobile terminal 20 (see FIG. 1) of the customer engineer is executed (step S115).

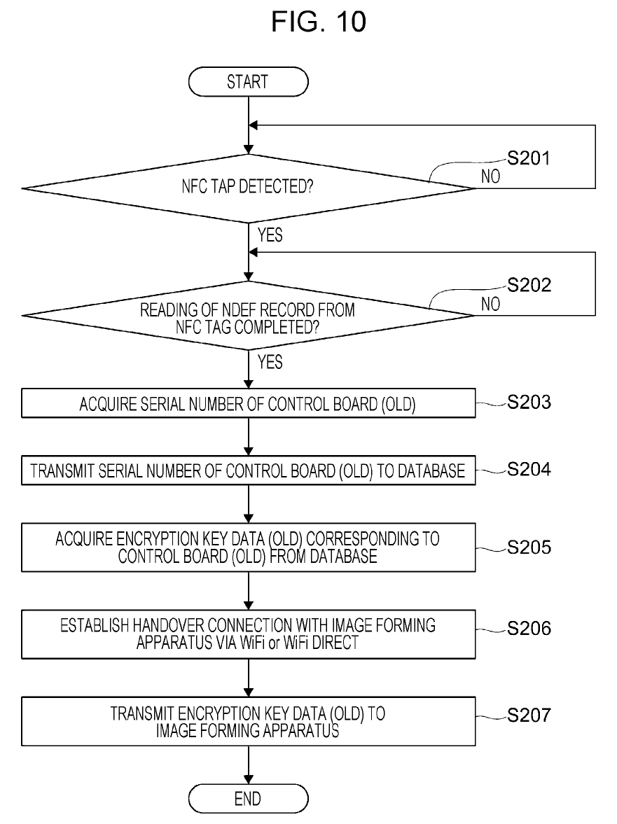

FIG. 10 is a flowchart illustrating the processing operation of the board replacement app 21 (see FIG. 6) installed in the mobile terminal 20. The processing operation of the board replacement app 21 is executed by the processor 201 (see FIG. 6). The board replacement app 21 is running in the background.

The processor 201 determines whether an NFC tap has been detected (step S201).

When no NFC tap has been detected, a negative result is obtained in step S201. In this case, the processor 201 repeats the determination processing in step S201.

When an NFC tap has been detected, a positive result is obtained in step S201. In this case, the processor 201 determines whether the reading of the NDEF record from the NFC tag 14 (see FIG. 3) has been completed (step S202).

When the reading of the NDEF record has not been completed, a negative result is obtained in step S202. In this case, the processor 201 repeats the determination processing in step S202.

When the reading of the NDEF record has been completed, a positive result is obtained in step S202. In this case, the processor 201 acquires the serial number of the control board (old) from the offset b of the NDEF record (see FIG. 9) (step S203). In the case of FIG. 9, the serial number of the control board (old) is "SN1000A".

Next, the processor 201 transmits the serial number of the control board (old) to the database 110 (see FIG. 1) (step S204). This transmission is executed via the network N (e.g., the Internet).

Afterward, the processor 201 acquires the encryption key data (old) corresponding to the control board (old) from the database 110 (step S205).

Subsequently, the processor 201 establishes a handover connection with the image forming apparatus 10 (see FIG. 1) via Wi-Fi or Wi-Fi Direct (step S206). Information necessary for a handover connection with the image forming apparatus 10 is read from the NFC tag 14 (see FIG. 3) when an NFC tap is performed.

Afterward, the processor 201 transmits the encryption key data (old) to the image forming apparatus 10 (step S207).

A reference is made back to the description of FIG. 8.

After Step S114, the processor 101 of the image forming apparatus 10 determines whether the encryption key data of the control board (old) has been received (Step S116).

When the encryption key data of the control board (old) has not been received, a negative result is obtained in step S116. In this case, the processor 101 repeats the determination processing in step S116.

When the board replacement app 21 is not installed in the mobile terminal 20 (see FIG. 1) used for the NFC tap, it is difficult to acquire the encryption key data (old) from the database 110 (see FIG. 1) even though the NDEF record can be read.

In this case, a negative result continues in step S116. In this case, the processor 101 may display, for example, a screen for prompting installation of the board replacement app 21 on the control panel 11 (see FIG. 3). The display condition requires, for example, that the determination time in step S116 exceeds a threshold (time).

Conversely, when reception of the encryption key data of the control board (old) is confirmed, a positive result is obtained in step S116. In this case, the processor 101 decrypts the received encryption key data with the common key (step S117). Hereinafter, the decrypted encryption key is referred to as the "encryption key (old)".

Then, the processor 101 decrypts the encrypted data (old) backed up in the backup non-volatile memory 106 with the decrypted encryption key (old) to generate plain-text user data (step S118).

The encrypted data (old) to be decrypted is the user data that has been copied from the master non-volatile memory 105 to the backup non-volatile memory 106 in step S110 (see FIG. 7).

Then, the processor 101 encrypts the plain-text user data with the encryption key of the control board (new) to generate encrypted data (new) (step S119).

Then, the processor 101 stores the encrypted data (new) in the backup non-volatile memory 106 (step S120).

Subsequently, the processor 101 stores the generated encrypted data (new) in the master non-volatile memory 105 (see FIG. 3) (step S121).

The storage here may be by overwriting the encrypted data (old) taken over from the control board (old) before replacement. Alternatively, the encrypted data (old) may be deleted from the backup non-volatile memory 106 after the encrypted data (new) is stored.

Subsequently, the processor 101 reads the serial number of the control board (new) from the backup non-volatile memory 106 and overwrites with the serial number to the master non-volatile memory 105 (step S122). Accordingly, the mismatch between the control board (new) and the serial number stored in the master non-volatile memory 105, which has been replaced from the control board (old) to the control board (new), is resolved.

Afterward, the processor 101 terminates the diagnostic mode of the UEFI and executes the firmware.

### Control Board Replacement Work and Process Flow

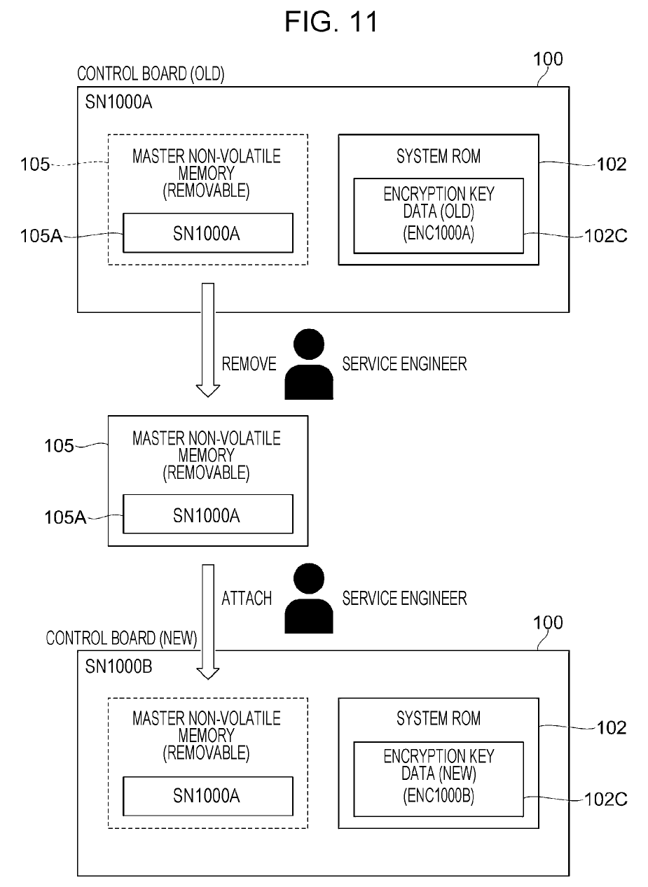

FIG. 11 is a diagram illustrating replacement work of the control board 100 described in steps S102 to S104 (see FIG. 7). In FIG. 11, the parts corresponding to the parts in FIGS. 1 and 5 are denoted by the corresponding reference numerals.

In FIG. 11, the serial number of the control board (old) removed from the image forming apparatus 10 is "SN1000A". In this case, the serial number (i.e., "SN1000A") 105A unique to the control board (old) is recorded in the master non-volatile memory 105.

In the system ROM 102, the data (i.e., encryption key data (old)) 102C obtained by encrypting the encryption key unique to the control board (old) is recorded. In the case of FIG. 11, "ENC1000A" corresponding to "SN1000A" is recorded.

The customer engineer removes the master non-volatile memory 105 from the control board (old) and attaches the master non-volatile memory 105 to the new control board 100 (i.e., the control board (new)).

In the case of FIG. 11, the serial number of the control board (new) is "SN1000B".

For this reason, the encryption key data (new) (i.e., "ENC1000B") 102C corresponding to "SN1000B" is recorded in the system ROM 102 of the control board (new).

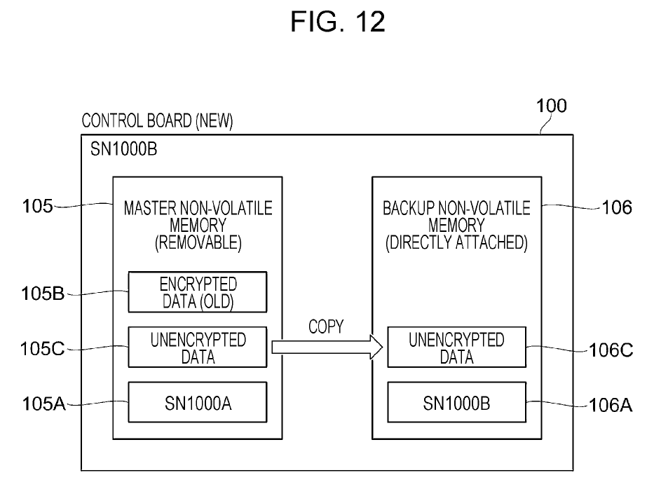

FIG. 12 is a diagram illustrating the processing operation in step S110 (see FIG. 7). In FIG. 12, the parts corresponding to the parts in FIGS. 1 and 5 are denoted by the corresponding reference numerals.

The control board (new) illustrated in FIG. 12 has already been attached to the image forming apparatus 10 (see FIG. 1), and the diagnostic mode of the UEFI 102B (see FIG. 5) has started.

As illustrated in FIG. 12, the serial number 105A of the control board (new) is "SN1000B". However, the serial number 105A of the master non-volatile memory 105 taken over from the control board (old) is "SN1000A".

Furthermore, the serial number 106A of the backup non-volatile memory 106 is the same as the serial number of the control board (new).

In this state, the unencrypted data 105C is first copied from the master non-volatile memory 105 to the backup non-volatile memory 106.

The encrypted data 106B (see FIG. 5) is not recorded in the backup non-volatile memory 106 immediately after replacement.

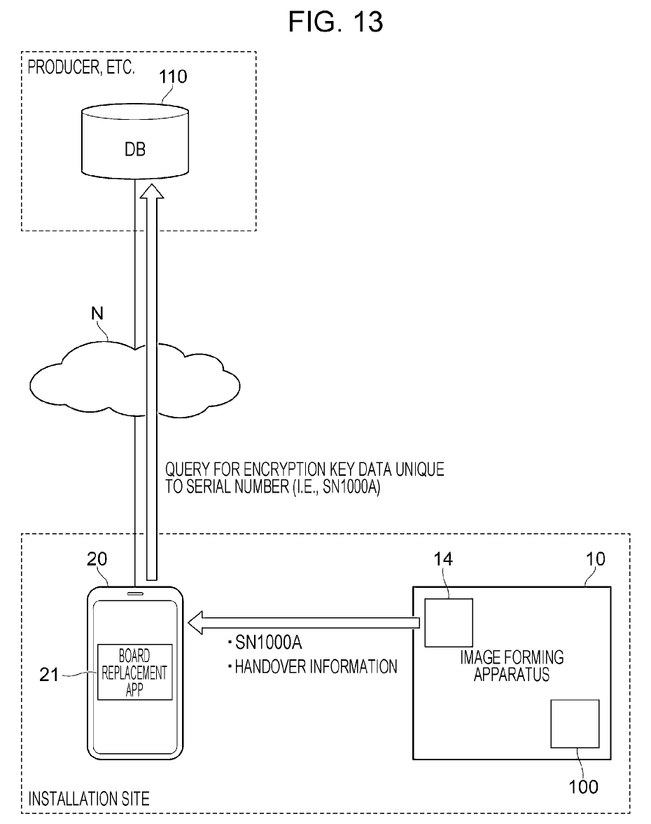

FIG. 13 is a diagram illustrating the processing operation in step S115 (see FIG. 8). In FIG. 13, the parts corresponding to the parts in FIGS. 1 and 3 are denoted by the corresponding reference numerals.

FIG. 13 illustrates a data flow during an NFC tap.

First, by the NFC tap, the serial number (i.e., "SN1000A") of the control board (old) and the handover information are read to the mobile terminal 20. The serial number here is an example of first serial information.

Then, the mobile terminal 20 queries the database 110 for the encryption key data unique to the acquired serial number (i.e., SN1000A) through the board replacement app 21.

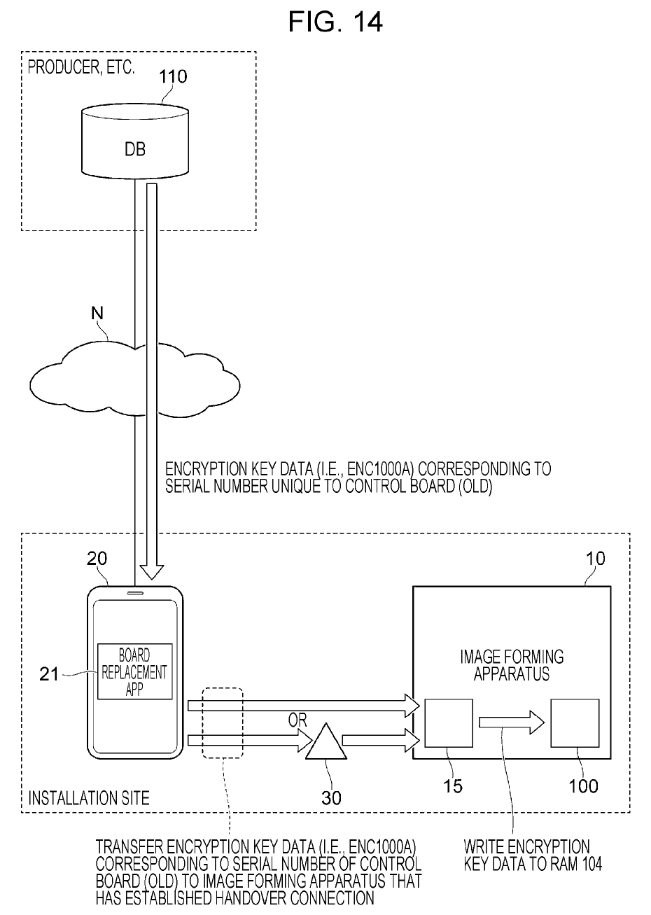

FIG. 14 is a diagram illustrating the processing operation in steps S115 and S116 (see FIG. 8). In FIG. 14, the parts corresponding to the parts in FIGS. 1 and 3 are denoted by the corresponding reference numerals.

The database 110 stores the encryption key data 110B (see FIG. 2) unique to the control board (old) in association with the serial number 110A (see FIG. 2) of the control board (old).

In FIG. 14, the encryption key data (i.e., ENC1000A) corresponding to the serial number of the control board (old) is read to the mobile terminal 20.

Then, the mobile terminal 20 transfers the encryption key data (i.e., ENC1000A) corresponding to the serial number of the control board (old) to the image forming apparatus 10 that has established a handover connection. Afterward, the image forming apparatus 10 writes the encryption key data in the RAM 104.

The RAM 104 is a volatile memory. Therefore, when the main power is turned off, all the data (including the encryption key data) stored in the RAM 104 is deleted.

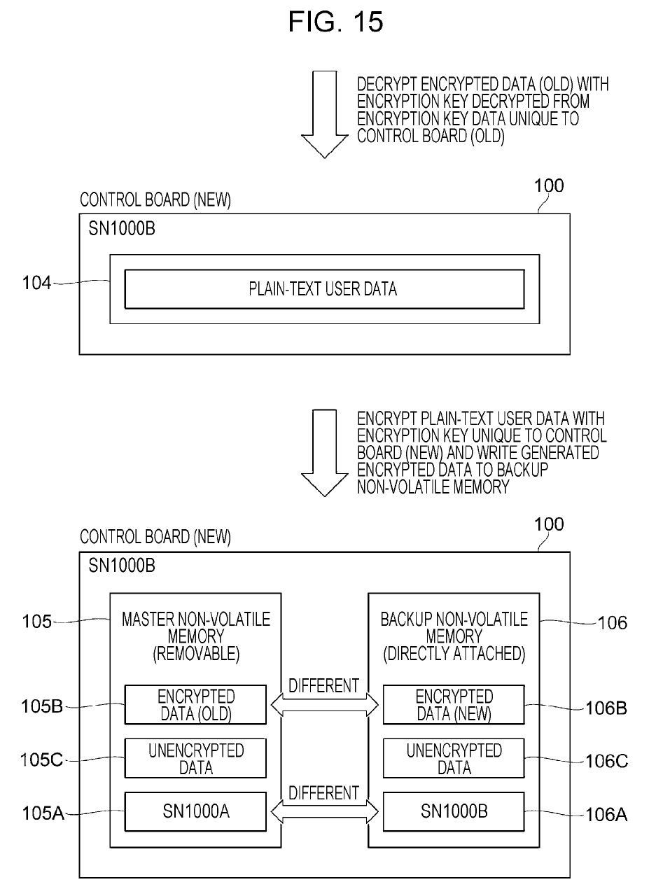

FIG. 15 is a diagram illustrating the processing operation in steps S117 to S120 (see FIG. 8). In FIG. 15, the parts corresponding to the parts in FIGS. 1, 3, and 5 are denoted by the corresponding reference numerals.

In the image forming apparatus 10, the encrypted data (old) is decrypted with the encryption key (i.e., KEY_A) decrypted from the encryption key data (i.e., ENC1000A) unique to the control board (old) before replacement. The plain-text user data generated by decryption is stored in the RAM 104.

Then, the image forming apparatus 10 encrypts the plain-text user data with the encryption key (i.e., KEY_B) unique to the control board (new) and writes the generated encrypted data 106B to the backup non-volatile memory 106. KEY_B is an example of a second encryption key.

The encrypted data 105B encrypted with the encryption key (i.e., KEY_A) unique to the control board (old) is still stored in the master non-volatile memory 105.

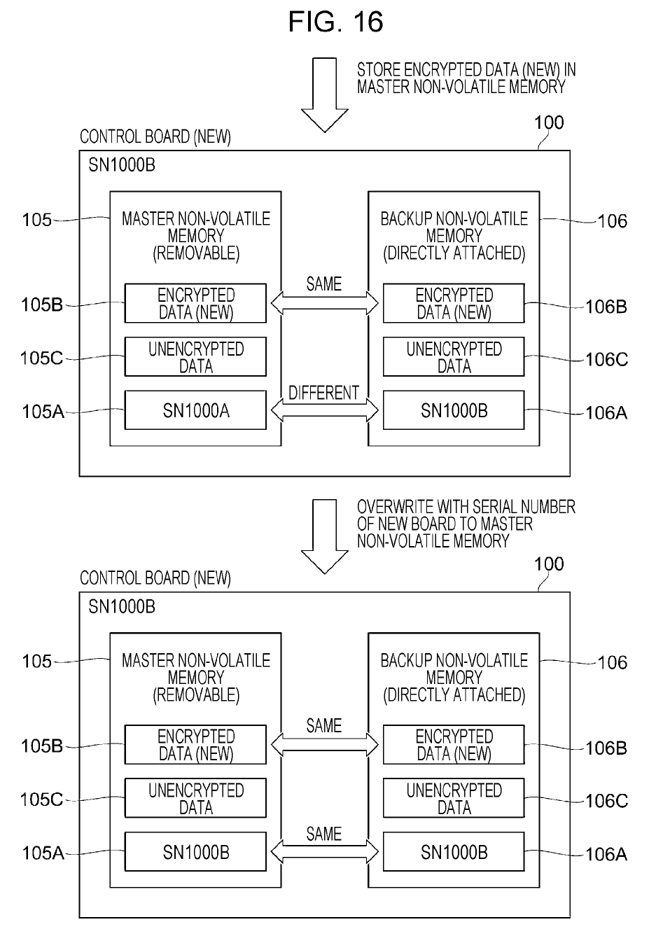

FIG. 16 is a diagram illustrating the processing operation in steps S121 and S122 (see FIG. 8). In FIG. 16, the parts corresponding to the parts in FIGS. 1, 3, and 5 are denoted by the corresponding reference numerals.

When the encrypted data (new) encrypted with the encryption key (i.e., KEY_B) unique to the new control board (new) is generated, the image forming apparatus 10 stores the encrypted data (new) in the master non-volatile memory 105. As a result, the same encrypted data (new) is stored in both the master non-volatile memory 105 and the backup non-volatile memory 106.

Finally, the serial number (i.e., SN1000A) stored in the master non-volatile memory 105 is overwritten with the serial number (i.e., SN1000B) unique to the new control board (new). As a result, the same serial number (i.e., SN1000B) is stored in both the master non-volatile memory 105 and the backup non-volatile memory 106.

### Summary

Even when the master non-volatile memory 105 (see FIG. 3) removed from the control board (old) is attached to the control board (new), the encrypted data of the control board (old) can be used by the control board (new).

According to the present exemplary embodiment, the encrypted data is taken over by the communication between the newly attached control board (new) and the mobile terminal 20. Therefore, the image forming apparatus 10 does not need to be provided with a different board used to take over the encrypted data. As a result, the device configuration of the image forming apparatus 10 is simplified.

### Other Exemplary Embodiments

(1) Although the exemplary embodiment of the present disclosure has been described above, the technical scope of the present disclosure is not limited to the scope described in the embodiment above. It is apparent from the scope of claims that various changes and improvements to the above-described embodiment are also included in the technical scope of the present disclosure.

(2) In the case described according to the above exemplary embodiment, the customer engineer replaces the control board 100 (see FIG. 1), but a user of the image forming apparatus 10 may replace the control board 100.

(3) In the case described according to the above exemplary embodiment, the board replacement app 21 is installed in the mobile terminal 20 (see FIG. 1) carried by the customer engineer, but the board replacement app 21 may be installed in any terminal.

(4) In the case described according to the above exemplary embodiment, the control board 100 of the image forming apparatus 10 (see FIG. 1) is replaced, but the target device is not limited to the image forming apparatus 10. The target device may be any device as long as the encrypted user data is stored in the master non-volatile memory 105 (see FIG. 3).

(5) According to the above exemplary embodiment, the board's unique serial number and the handover information are transmitted to the mobile terminal 20 (see FIG. 1) by the NDF tap, but another communication interface may be used. For example, a USB cable or a LAN cable may be used to communicate various types of information. Alternatively, data may be exchanged using a USB memory, an SD card, or another removable recording medium.

(6) According to the above exemplary embodiment, the mobile terminal 20 notifies the image forming apparatus 10 of the encryption key data (old) unique to the control board (old) via Wi-Fi or Wi-Fi Direct, but another communication interface may be used. For example, a USB cable or a LAN cable may be used to communicate various types of information. Alternatively, data may be exchanged using a USB memory, an SD card, or another removable recording medium.

(7) According to the exemplary embodiment described above, each processing is executed by any computer. In addition, the arbitrary computer may execute each processing by a processor as hardware, a program as software, or a combination thereof.

In this case, the processor is configured to perform the processes in the exemplary embodiments in cooperation with the program and may function as a unit or a means in the exemplary embodiments.

In addition, the execution order of the processing by the processor is not limited to the described order, and may be appropriately changed. The arbitrary computer may be a general purpose computer, a special purpose computer, a workstation, or any other system capable of performing each processing.

The processor may be configured by one or more pieces of hardware, and the type of hardware is not limited. For example, the processor may be configured by a programmable logic device such as a central processing unit (CPU), a micro processing unit (MPU), or a field programmable gate array (FPGA), a dedicated circuit for executing specific processing, such as an application specific integrated circuit (ASIC), or hardware such as a graphic processing unit (GPU) or a neural processing unit (NPU).

Further, the type of hardware may be a combination of different types of hardware. When a plurality of pieces of hardware is configured to execute one or more processes of a certain processor, the plurality of pieces of hardware may exist in devices physically separated from each other, or may exist in the same device. In addition, according to any exemplary embodiment, the order of the processes performed by the processor is not limited to the order described above, and may be appropriately changed. The hardware is configured by an electric circuit (circuitry) in which circuit elements such as semiconductor elements are combined.

Further, the program may be software such as firmware or microcode. In addition, the program may be, for example, a program module group, and each function thereof may be realized by a processor configured to execute each function. The program may be a program code or a plurality of code segments stored in one or more non-transitory computer-readable media (e.g., storage media or other storage).

The program may be divided and stored in a plurality of non-transitory computer-readable media that exist in devices physically separated from each other. The program code or the code segments may represent procedures, functions, subprograms, routines, subroutines, modules, software packages, classes, or any combination of instructions, data structures, or program statements. The program code or the code segments may be coupled to other code segments or hardware circuits by transmitting and receiving information, data, arguments, parameters, or memory contents.

(8) The exemplary embodiments of the present disclosure are also applicable to programs and program products.

### Appendix

(((1))) An information processing apparatus comprising a processor configured to: in a case where, after replacement of a first board with a second board, first encrypted data stored in a storage device taken over from the first board to the second board fails to be decrypted, acquire, from an external device connected via a different terminal, first encryption key data obtained by encrypting a first encryption key unique to the first board; and decrypt the first encrypted data by using the first encryption key decrypted from the acquired first encryption key data.

(((2))) The information processing apparatus according to (((1))), wherein the external device stores serial information unique to a board and encryption key data obtained by encrypting a corresponding encryption key, and the processor is configured to: provide the different terminal with first serial information that is read from the storage device and is unique to the first board; and acquire the first encryption key data corresponding to the first serial information from the different terminal.

(((3))) The information processing apparatus according to (((2))), wherein the processor is configured to: provide the first serial information to the different terminal via a first communication interface; and acquire the first encryption key data from the different terminal via a second communication interface different from the first communication interface.

(((4))) The information processing apparatus according to (((3))), wherein the first communication interface is Near Field Communication (NFC), and the second communication interface is a wireless local area network.

(((5))) The information processing apparatus according to (((4))), wherein when a maintenance mode is started, the processor is configured to read the first serial information from the storage device and store the first serial information in an NFC module.

(((6))) The information processing apparatus according to any one of (((1))) to (((5))), wherein the processor is configured to encrypt data obtained by decrypting the first encrypted data with a second encryption key unique to the second board and store the encrypted data in the storage device.

(((7))) An information terminal comprising a processor configured to: communicate with an information processing apparatus that, after replacement of a first board with a second board, has failed to decrypt first encrypted data stored in a storage device taken over from the first board to the second board; read serial information of the first board from the information processing apparatus, acquire, from an external device, first encryption key data obtained by encrypting a first encryption key unique to the first board corresponding to the serial information; and transmit the acquired first encryption key data to the information processing apparatus.

(((8))) A program causing a computer to execute a process comprising: in a case where, after replacement of a first board with a second board, first encrypted data stored in a storage device taken over from the first board to the second board fails to be decrypted, acquiring, from an external device connected via a different terminal, first encryption key data obtained by encrypting a first encryption key unique to the first board; and decrypting the first encrypted data by using the first encryption key decrypted from the acquired first encryption key data.

What is claimed is:

1. An information processing apparatus comprising:
a processor configured to:
in a case where, after replacement of a first board with a second board, first encrypted data stored in a storage device taken over from the first board to the second board fails to be decrypted,
acquire, from an external device connected via a different terminal, first encryption key data obtained by encrypting a first encryption key unique to the first board; and
decrypt the first encrypted data by using the first encryption key decrypted from the acquired first encryption key data.

2. The information processing apparatus according to claim 1, wherein
the external device stores serial information unique to a board and encryption key data obtained by encrypting a corresponding encryption key, and
the processor is configured to:
provide the different terminal with first serial information that is read from the storage device and is unique to the first board; and
acquire the first encryption key data corresponding to the first serial information from the different terminal.

3. The information processing apparatus according to claim 2, wherein the processor is configured to:
provide the first serial information to the different terminal via a first communication interface; and
acquire the first encryption key data from the different terminal via a second communication interface different from the first communication interface.

4. The information processing apparatus according to claim 3, wherein
the first communication interface is Near Field Communication (NFC), and
the second communication interface is a wireless local area network.

5. The information processing apparatus according to claim 4, wherein when a maintenance mode is started, the processor is configured to read the first serial information from the storage device and store the first serial information in an NFC module.

6. The information processing apparatus according to claim 1, wherein the processor is configured to encrypt data obtained by decrypting the first encrypted data with a second encryption key unique to the second board and store the encrypted data in the storage device.

7. An information terminal comprising:
a processor configured to:
communicate with an information processing apparatus that, after replacement of a first board with a second board, has failed to decrypt first encrypted data stored in a storage device taken over from the first board to the second board;
read serial information of the first board from the information processing apparatus;
acquire, from an external device, first encryption key data obtained by encrypting a first encryption key unique to the first board corresponding to the serial information; and
transmit the acquired first encryption key data to the information processing apparatus.

8. A non-transitory computer readable medium storing a program causing a computer to execute a process comprising:
in a case where, after replacement of a first board with a second board, first encrypted data stored in a storage device taken over from the first board to the second board fails to be decrypted,
acquiring, from an external device connected via a different terminal, first encryption key data obtained by encrypting a first encryption key unique to the first board; and
decrypting the first encrypted data by using the first encryption key decrypted from the acquired first encryption key data.
